(19) United States
(12) Patent Application Publication
(10) Pub. No.: US 2007/0197711 A1
(43) Pub. Date: Aug. 23, 2007

(54) Organoclay suitable for use in halogenated resin and composite systems thereof

(75) Inventors: Wouter L. Ijdo, Trenton, NJ (US); Wilbur S. Mardis, Holland, PA (US); Daphne Benderly, Metuchen, NJ (US)

Correspondence Address: MORGAN, LEWIS & BOCKIUS LLP, 1701 MARKET STREET, PHILADELPHIA, PA, 19103-2921, US

(73) Assignee: Elementis Specialties, Inc.

(21) Appl. No.: 11/707,494

(22) Filed: Feb. 16, 2007

Related U.S. Application Data
(60) Provisional application No. 60/774,833, filed on Feb. 17, 2006.

(51) Int. Cl. C08K 9/04

(52) U.S. Cl. 524/445; 523/216

(57) ABSTRACT

A polymer/organoclay composition having improved color stability. The composition includes a halogenated polymer matrix. It also includes an organoclay composition which is comprised of phyllosilicate clay and one or more quaternary ammonium compounds. The quaternary ammonium compounds include tri- and tetra-[poly]oxyalkylene quaternary ammonium compounds, the ether and ester derivatives thereof. The phyllosilicate clay phyllosilicate clay includes a smectite clay and the polymer includes polyvinyl chloride. The polymer/organoclay composition includes quaternary ammonium compounds selected from the following: tris[2-hydroxyethyl]tallow alkyl ammonium ion, tris[2-hydroxyethyl]hydrogenated tallow alkyl ammonium ion and tris[2-hydroxyethyl]stearyl alkyl ammonium ion.

### RELATED APPLICATIONS

This application claims the benefit of U.S. Provisional Application No. 60/774,833 filed Feb. 17, 2006 entitled “Organoclay Suitable for Use in Halogenated Resin and Composite Systems Thereof” which is incorporated herein by reference in its entirety.

### FIELD OF THE INVENTION

The present invention is directed to improved organoclay compositions which may be added to various fluids and/or polymer matrices resulting in materials having enhanced materials properties.

### BACKGROUND

Organoclays have been widely utilized as rheology modifiers for paint and coatings, inks, greases, oil well drilling fluids but find also use as additives in plastics to improve a variety of properties such as barrier, mechanical, anti-static and flame retardant properties.

Conventional organoclays cause halogenated resins such as PVC to degrade when heated to temperatures above about 250° F. Such temperatures are frequently encountered during a baking or compounding operation. When conventional organoclays are incorporated in halogenated resins such as PVC, the plastic rapidly turns black and brittle during the compounding process which is usually undesirable. An example of such a conventional organoclay is, for instance, BENTONE® 34, a bentonite clay-based product that is hydrophobically modified with a dimethyldialkyl quaternary ammonium compound.

Certain organoclays cause less degradation and discoloration of halogenated resins when they are compounded into the matrix. Organoclays based on diethanol methyl alkyl quaternary ammonium compounds are examples. Examples of such organoclays are EA-2700 and EA-2533, both available from Elementis Specialties, or Cloisite 30B, available from Southern Clay Products. These three clays are all treated with diethanol quaternary ammonium compounds. However, the organoclays do still deteriorate the halogenated resin and this has limited their application success.

The organoclay/polymer compositions of the current invention show unexpected compatibility between an organoclay and halogenated resin where the compatibility is manifested by reduced degradation of the halogenated resin over the prior art organoclay/polymer compositions. The polymer degradation affects polymer properties such as color, brittleness and other mechanical properties.

### SUMMARY OF THE INVENTION

The present invention provides for polymer/organoclay compositions having improved compatibility, between the organoclay and polymer, resulting in enhanced material properties. The compositions include halogenated polymer matrices. It also includes organoclay compositions which contain phyllosilicate clay and one or more quaternary ammonium compounds including tri- and tetra-[poly]oxyalkylene quaternary ammonium compounds, wherein poly means one or more oxyalkylene groups, and the ether and ester derivatives thereof. In one embodiment, the phyllosilicate clay includes clays that undergo ion exchange reactions with quaternary ammonium cations forming an organoclay. In certain embodiments, the organoclay of the polymer/organoclay composition includes quaternary ammonium compounds such as tris[2-hydroxyethyl]tallow alkyl ammonium ion, tris[2-hydroxyethyl]hydrogenated tallow alkyl ammonium ion and tris[2-hydroxyethyl]stearyl alkyl ammonium ion. In one embodiment, the polymer includes halogenated polymers including homopolymers, copolymers and blends of halogenated polymers. In another embodiment, the halogenated polymer includes polyvinyl chloride.

### BRIEF DESCRIPTION OF THE DRAWINGS

The accompanying drawing, which is included to provide further understanding of the disclosure and is incorporated in and constitute a part of this specification, illustrates embodiments of the disclosure and, together with the description, serve to explain the principles of the disclosure.

FIG. 1 illustrates the CIE color test results of an embodiment of the present invention.

### DESCRIPTION OF THE EMBODIMENTS

The organoclays of the current invention are based on combinations of or reaction products of phyllosilicate clays and tri- and tetra-[poly]oxyalkylene quaternary ammonium compounds and the ether and ester derivatives thereof. Organoclays comprised of these quaternary ammonium compounds do not degrade halogenated resins to the extent as observed for organoclays based on non-alkoxylated or even mono- or dialkoxylated quaternary ammonium compounds.

The organoclays of this invention may be incorporated into halogenated resins to form compositions that are useful for barrier applications, particularly gas barrier for oxygen and carbon dioxide, but also moisture barrier. Also, the use of the organoclays of this invention in halogenated resins can enhance the flame retardancy. The organoclays of this invention may also be used as a filler to enhance plastics mechanical properties or anti-static properties. The organoclays may also be used as a theological additive in fluid systems, or as an anti settling additive.

The preferred phyllosilicate clays are smectite clays which are layered, platy, hydrophilic silicate materials. In the dry state, several nano-sized clay layers are normally stacked on top of each other and these stacks, or tactoids, are agglomerated into particles. However, the platelets spontaneously separate from each other when dry clay powder is dispersed in water. This “delamination of layers” is at times also referred to as “exfoliation of layers.” Smectite clay layers carry a net negative charge on the platelets that is neutralized by metal cations that are positioned on the surfaces of the platelets. An organoclay is formed when the metal cations are exchanged with organic cations. This reaction may be partially completed or driven to completion. Organic surface treatment is often necessary to improve the compatibility of the clay with organic systems. Similar to “pristine” inorganic clays in water, organoclays can delaminate in organic systems (solvents, polymers): i.e. the clay layers that are now decorated with organic cations are separated from each other when they are exfoliated in said systems.

The nanocomposite of the present invention may contain organoclay in any dispersed state including agglomerates, particles, tactoids or as fully dispersed platelets and mixtures thereof.

The phyllosilicate clay, quaternary ammonium compounds, and organoclay/polymer compositions of this invention may be made using a variety of materials and by a variety of methods. The clay includes natural or synthetic phyllosilicate clay, or mixtures thereof, which undergo ion exchange reactions with quaternary ammonium cations forming an organoclay. Representative natural phyllosilicate clays include smectites, vermiculites, and micas. Examples of smectite-type clays include montmorillonite, bentonite, hectorite, saponite, stevensite, and beidellite. Swelling clays such as hectorite and Wyoming-type bentonite are preferred. Bentonite and its properties are described at length in the chapter entitled “Bentonite,” in Carr, D., ed. 1994, Industrial Minerals and Rocks, 6th Edition (published by the Society For Mining, Metallurgy and Exploration, Colorado). Smectite-type clays are well known in the art and are commercially available from a variety of sources. Smectite clays useful in accordance with the present invention are described in detail in “Hydrous Phyllosilicates, Reviews in Mineralogy, Volume 19, S. W. Bailey, editor.”

In an embodiment employing natural phyllosilicate clay, the clay may include crude clay or beneficiated clay. The crude clay contains gangue or non-clay material whereas the gangue material has been largely removed from the beneficiated clay. In an embodiment using crude clay, substantial cost savings may be realized because the steps for the clay beneficiation process and conversion to the sodium form are eliminated.

Representative synthetic phyllosilicate clays include synthetic vermiculite, synthetic smectite, synthetic hectorite, synthetic fluorohectorite and synthetic mica. The performance of synthetic clay based organoclays may differ, either positively or negatively, from those based on naturally occurring clays. These differences may be due to chemical composition and homogeneity thereof, ion exchange capacity, location of the ion exchange sites, impurities, surface area, platelet size and distribution, and/or other reasons. These clays, also, may optionally be purified if desired.

The exchangable inorganic cations of the phyllosilicate clay may be sodium or another cation. Preferably the exchangeable cations will be sodium. In one embodiment, the sodium form of the smectite clay may be used. To prepare the sodium form of one embodiment, bentonite clay may be converted to the sodium form by preparing an aqueous clay slurry and passing the slurry through a bed of cation exchange resin in the sodium form. In another embodiment, the sodium form of the smectite clay may be prepared by mixing the clay with water and a soluble sodium compound, such as sodium carbonate, sodium hydroxide, etc.

In an embodiment, the phyllosilicate clay includes smectite-type clay having a cation exchange capacity of at least 45 mMols per 100 grams of clay, 100% active clay basis, as determined by the well-known ammonium acetate method or equivalent method.

The clay may be either sheared or non-sheared forms of the above-listed smectite clays. In one embodiment, the sheared form of the smectite clay may provide improved performance of the polymer/organoclay composition. Elementis Specialties, Inc. and its predecessor have issued patents describing the shearing of smectite clay, as described in U.S. Pat. No. 4,695,402 and U.S. Pat. No. 4,742,098 which are incorporated herein by reference in their entirety.

The organoclays used in the organoclay/polymer composition of the present invention include one or more phyllosilicate clays and one or more quaternary ammonium cations and optionally additional organic material. The optional organic material may include neutral organic compounds and organic or polymeric anionic materials. The neutral organic compounds may include monomeric compounds, oligomeric compounds or polymeric compounds. The quaternary ammonium cations useful in this invention may be selected from a wide range of defined specific materials that are capable of forming an organophilic clay by exchange of cations with the smectite-type clay. The organic cation must have a positive charge localized on a single atom or on a small group of atoms within the compound.

Quaternary ammonium compounds degrade at elevated temperatures such as they may experience during the nanocomposite compounding operation. Tertiary amines and olefins are often among the degradation products. Like ammonia, most amines are Brønsted and Lewis bases. It is common to compare amine basicities quantitatively by using the pKa's of their conjugate acids rather than their pKb's. Since pKa+pKb=14, the higher the pKa the stronger the base, in contrast to the usual inverse relationship of pKa with acidity. The amine base strength can be influenced enormously by the type of substituents that are bonded to the nitrogen atom. Compare for example: trimethylamine (pKa=9.8); N,N-dimethylethanolamine (pKa=8.9); N-Methyldiethanolamine (pKa=8.5) and triethanolamine (pKa=7.8). Amines that are even significantly weaker also exist, compare for instance pyridine (pKa=5.2); aniline (pKa=4.6) and p-nitroaniline (pKa=1.0).

While not wishing to be bound by speculation, the inventors postulate that the amine degradation products that are formed when quaternary ammonium compounds degrade can be very detrimental to halogenated resins. Relatively strong amines can initiate the dehydrohalogenation reaction of halogen containing polymers accelerating polymer decomposition, whereas amines that are weak bases do not initiate the decomposition of halogen containing polymers and resins. In one embodiment, quaternary ammonium compounds useful in this invention yield amines upon degradation that have basicities lower than that of N-methyldiethanolamine (pKa=8.5). The empirical data suggests that such amines are not basic enough to attack the halogenated resin.

In one embodiment, the quaternary ammonium compound has formula (1):

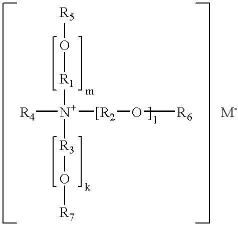

In another embodiment, the quaternary ammonium compound has formula (2):

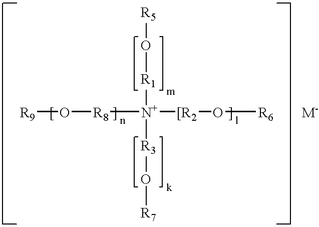

In formulas (1) and (2), M⁻ is the counterion for the quaternary ammonium cation. When the clay is in the form of a metal containing clay, the counter ion includes chloride, bromide, methylsulfate, ethylsulfate, acetate and sulfate. When the clay is in the proton form, the counter ion includes hydroxide, carbonate and acetate.

For the quaternary ammonium compound of formulas (1) and (2), R₁, R₂, R₃ and R₈ are independently selected from the following: branched or unbranched alkyl chains having from 2 to 22 carbon atoms; and branched or unbranched polyalkylene oxide groups having repeating units from 2 to 6 carbon atoms. Any of R₁, R₂, R₃ and R₈ may bear multiple oxygen-containing substituents, such as hydroxyls, esters, and ethers, so long as these are not alpha to the quaternary nitrogen and are not on the same carbon. In other words, R₁, R₂, R₃ and R₈ include one or more oxygen-containing substituents wherein said substituents are at least beta to nitrogen of said quaternary ammonium compound. R₄ is selected from the group consisting of a linear, branched or cyclic, saturated or unsaturated alkyl. R₅, R₆, R₇ and R₉ are independently selected from the group consisting of hydrogen, a linear, cyclic or branched aliphatic, aralkyl, aromatic, or halogenated aliphatic groups having 1 to 200 carbon atoms, or R₁₀. R₁₀ includes C(═O)X R₁₁ where X is a single bond, an oxygen (—O—) or a nitrogen (—NH—), and R₁₁ is selected from the group consisting of a linear, cyclic or branched aliphatic, aralkyl, aromatic, or halogenated aliphatic groups having 1 to 200 carbon atoms. Repeat units k, l, m and n are independently selected and have average values of 1 to 10.

In preferred embodiments of formulas (1) and (2), R₁, R₂, R₃ and R₈ are independently selected from the group of branched or unbranched alkyl chains having from 2 to 6 carbon atoms. In most preferred embodiments of formulas (1) and (2), R₁, R₂, R₃ and R₈ are independently selected from the group of alkyl chains having from 2 or 3 carbon atoms. Representative examples of R₁, R₂, R₃ and R₈ include: 2-hydroxyethyl(ethanol); 3-hydroxypropyl; 4-hydroxypentyl; 6-hydroxyhexyl; 2-hydroxypropyl(isopropanol); 2-hydroxybutyl; 2-hydroxypentyl; 2-hydroxyhexyl; 2-hydroxycyclohexyl; 3-hydroxycyclohexyl; 4-hydroxycyclohexyl; 2-hydroxycyclopentyl; 3-hydroxycyclopentyl; 2-methyl-2-hydroxypropyl; 1,1,2-trimethyl-2-hydroxypropyl; 2-phenyl-2-hydroxyethyl; 3-methyl-2-hydroxybutyl; and 5-hydroxy-2-pentenyl.

In certain embodiments, R₁, R₂, R₃ and R₈ include branched or unbranched polyalkylene oxide groups having repeating units from 2 to 6 carbon atoms and the polyalkylene oxide group may have an average of no more than 6 moles of alkoxylation per polyalkoxy group. In one embodiment, the alkylene oxide components of the polyalkylene oxide group may all be the same. In another embodiment, the alkylene oxide components of the polyalkylene oxide group may all be different. Representative examples include polyethylene oxides, polypropylene oxides and block and random copolymers of ethylene and propylene oxides.

In another embodiment, R₁, R₂, R₃ and R₈ may be substituted with an aromatic substituent independent of the 2 to 6 aliphatic carbon limitation.

Further for the quaternary ammonium cations of formulas (1) and (2), the R₄, R₅, R₆, R₇, R₉ and R₁₁ groups include branched, unbranched or cyclic, saturated or unsaturated, substituted or unsubstituted, alkyl, alkyl ester, aromatic radicals or combinations thereof and should have from 1 to 200 carbon atoms. Long chain alkyl groups may be derived from natural occurring oils including various vegetable oils, such as corn oil, coconut oil, soybean oil, cottonseed oil, castor oil and the like, as well as various animal oils or fats such as tallow oil. The alkyl groups may likewise be petrochemically derived such as from alpha olefins. Representative examples of useful branched, saturated groups include iso-stearyl, 12-methylstearyl; and 12-ethylstearyl. Representative examples of useful branched, unsaturated groups include 12-methyloleyl and 12-ethyloleyl. Representative examples of unbranched saturated groups include lauryl; stearyl; tridecyl; myristyl(tetradecyl); pentadecyl; hexadecyl; hydrogenated tallow, docosonyl. Representative examples of unbranched, unsaturated and unsubstituted groups include oleyl, linoleyl; linolenyl, soya and tallow. Representative examples of an aralkyl group, that is benzyl and substituted benzyl moieties, would include benzyl and those materials derived from e.g. benzyl halides, benzhydryl halides, trityl halides, alpha-halo alpha-phenylalkanes wherein the alkyl chain has from 1 to 22 carbon atoms such as 1-halo-1-phenylethane; 1-halo-1-phenyl propane; and 1-halo-1-phenyloctadecane; substituted benzyl moieties such as would be derived from ortho-, meta-, and para-chlorobenzyl halides, para-methoxybenzyl halides; ortho-, meta- and para-nitrilobenzyl halides, and ortho-, meta- and para-alkylbenzyl halides wherein the alkyl chain contains from 1 to 22 carbon atoms; and fused ring benzyl type moieties such as would be derived from 2-halomethylnaphthalene, 9-halomethylanthracene and 9-halomethylphenanthrene, wherein the halo group would be defined as chloro, bromo, iodo, or any other such group which serves as a leaving group in the nucleophilic attack of the benzyl type moiety such that the nucleophile replaces the leaving group on the benzyl type moiety. Furthermore, these groups may be halogenated alkyl chains, having from 1 to 200 carbon atoms and may for instance be derived from ethylene chloride or ethylidene chloride.

Repeat units k, l, m, and n, of formulas (1) and (2), are independently selected and can be achieved through (co)-polymerization of ethylene oxide, propylene oxides and/or other alpha-olefin epoxides.

In certain embodiments for formula (2), the quaternary ammonium compound includes structures where R₁, R₂ and R₃ are each ethyl groups and R₅, R₆ and R₇ are hydrogen. In a preferred embodiment, the quaternary ammonium cation includes or is tris[2-hydroxyethyl]tallow alkyl ammonium. In another preferred embodiment, the quaternary ammonium cation includes or is tris[2-hydroxyethyl]hydrogenated tallow alkyl ammonium. In yet another preferred embodiment, the quaternary ammonium cation includes or is tris[2-hydroxyethyl]stearyl alkyl ammonium. In still yet another preferred embodiment, the quaternary ammonium compound includes or is Ethoquad® T/13-27W (Manufactured by AKZO-Nobel), a tris[2-hydroxyethyl]tallow alkyl ammonium acetate.

In another preferred embodiment, formula (1) includes 1-propaminium, 3-(dodecyloxy)-2-hydroxy-N,N-bis[2-hydroxyethyl]-N-methyl-chloride having the following structure:

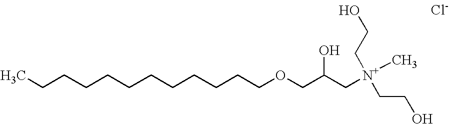

In certain embodiments for formula (1), at least one of R₅, R₆ and R₇ include hydrogen and at least one of R₅, R₆ and R₇ do not include hydrogen. In other embodiments for formula (1), R₅, R₆ and R₇ do not include hydrogen. In yet other embodiments for formula (1), R₅, R₆ and R₇ are hydrogen.

In an embodiment for formula (2), R₅ is hydrogen and R₆, R₇ and R₉ are not hydrogen. In a second embodiment for formula (2), R₅ and R₆ are hydrogen and R₇ and R₉ are not hydrogen. In a third embodiment for formula (2), R₅, R₆ and R₇ are hydrogen and R₉ is not hydrogen. In a fourth embodiment for formula (2), R₅, R₆, R₇ and R₉ are not hydrogen. In yet another embodiment for formula (2), R₅, R₆, R₇ and R₉ are hydrogen.

In one embodiment, the quaternary ammonium cation is used in sufficient quantity to satisfy 50 to 150% of the clay's cation exchange capacity (“CEC”). In another embodiment, the quaternary ammonium cation is used in sufficient quantity to satisfy 75 to 125% of the clay's CEC. In a preferred embodiment, the quaternary ammonium cation is used in sufficient quantity to satisfy about 100% of the clay's CEC. For purposes of this application, “about” means plus or minus 5%. Use of less than an amount of the quaternary ammonium cation to satisfy both the cation exchange capacity of the clay and of the optional organic anionic material may result in unfavorable processing conditions. However, it will be recognized that the preferred amount of quaternary ammonium cation will vary depending on the characteristics of the plastic system to be enhanced by the organoclay.

For convenience of handling, it is preferred that the total organic content of the organophilic clay reaction products of this invention should be less than about 50% by weight of the organoclay. While higher amounts are usable the reaction product may be difficult to grind and process.

The optional organic materials (c) useful in this invention may be selected from a wide range of materials such as the non-anionic organic polymers disclosed in U.S. Pat. No. 6,380,295 and U.S. Pat. No. 6,794,437 and the anionic materials disclosed in U.S. Pat. No. 4,412,018, each of which is incorporated by reference herein its entirety. The optional organic materials may also include nonpolymeric, non-anion materials. A least a portion of the optional organic materials will become intercalated with a smectite-type clay during the preparation of the organoclay.

In one embodiment, the organophilic clays of this invention can be prepared by admixing the clay, quaternary ammonium compound (and optional organic materials) and water together, preferably at a temperature within the range from 20° C. to 100° C., and most preferably from 35° C. to 77° C. for a period of time sufficient for the organic compound(s) to react and intercalate with the clay, followed by filtering, washing, drying and grinding. The clay is preferably dispersed in water at a concentration from about 1 to 80% and preferably 2% to 7%, all percentages by weight. The slurry is optionally centrifuged to remove non-clay impurities which may constitute about 10% to about 50% of the starting clay composition, the slurry agitated and heated to a temperature in the range from 35° C. to 77° C. The quaternary ammonium salt is then added in the desired amount, preferably as a liquid, a solution in an organic solvent or dispersed in water and the agitation continued to effect the reaction.

The organoclays of this invention may be combined with a variety of polymer matrices comprising thermoplastic resins, thermoset resins and thermoplastic elastomer resins.

The polymer matrices include halogenated polymer resins such as halogenated rubber, polychloroprene, polyvinyl chloride (“PVC”), polyvinylidene chloride (“PVDC”), vinylidene chloride-vinyl chloride copolymers, vinyl chloride copolymers, vinylidene fluoride polymers, polyvinylidene fluoride (“PVDF”) and polytetrafluoroethylene (“PTFE”). In one embodiment, the matrix polymer includes polyvinyl chloride. In another embodiment, the matrix polymer includes polyvinylidene chloride.

In one embodiment, a polyvinyl halide matrix is combined with an organoclay composition. The organoclay composition comprises smectite clay and quaternary ammonium cation. In one embodiment, the polyvinyl halide matrix is combined with an organoclay, where the organoclay contains cations such as tris[2-hydroxyethyl]tallow alkyl ammonium ion, tris[2-hydroxyethyl]hydrogenated tallow alkyl ammonium ion and tris[2-hydroxyethyl]stearyl alkyl ammonium ion. In a preferred embodiment, the polyvinyl halide matrix is combined with an organoclay prepared by exchanging the clay with tris[2-hydroxyethyl]tallow alkyl ammonium acetate. In another embodiment, the polyvinyl halide matrix is combined with an organoclay, where the organoclay contains ester quaternary ammonium cations prepared by the reaction of methyltriethanolammonium cations where the ethanol groups have been esterifed with plant or animal derived fatty acids, linear or branched alkyl acids having from 2 to 30 carbon atoms.

In another embodiment, polyvinyl chloride is combined with an organoclay composition. The organoclay composition comprises smectite clay and quaternary ammonium cation. In one embodiment, the polyvinyl chloride is combined with an organoclay, where the organoclay contains cations such as (2-hydroxyethyl)tallow alkyl ammonium ion, tris[2 hydroxyethyl]hydrogenated tallow alkyl ammonium ion and tris[2-hydroxyethyl]stearyl alkyl ammonium ion. In a preferred embodiment, polyvinyl chloride is combined with an organoclay exchanged with tris[2-hydroxyethyl]tallow alkyl ammonium acetate. In another embodiment, polyvinyl chloride is combined with an organoclay, where the organoclay contains ester quaternary ammonium cations prepared by the reaction of methyltriethanolammonium cations where the ethanol groups have been esterfied with plant or animal derived fatty acids, linear or branched alkyl acids having from 2 to 30 carbon atoms.

In yet another embodiment, polyvinylidene chloride is combined with an organoclay composition. The organoclay composition comprises smectite clay and quaternary ammonium cation. In one embodiment, the polyvinylidene chloride is combined with an organoclay, where the organoclay contains cations such as (2-hydroxyethyl)tallow alkyl ammonium ion, tris[2-hydroxyethyl]hydrogenated tallow alkyl ammonium ion and tris[2-hydroxyethyl]stearyl alkyl ammonium ion. In a preferred embodiment, polyvinylidene chloride is combined with an organoclay exchanged with tris[2-hydroxyethyl]tallow alkyl ammonium acetate. In another embodiment, polyvinylidene chloride is combined with an organoclay, where the organoclay contains ester quaternary ammonium cations prepared by the reaction of methyltriethanolammonium cations where the ethanol groups have been esterfied with plant or animal derived fatty acids, linear or branched alkyl acids having from 2 to 30 carbon atoms.

The organoclay/halogenated resin may contain various amounts of organoclay. In one embodiment, the amount of organoclay, in the organoclay/halogenated resin composition, ranges from 0.1 to 50 weight percent. In another embodiment, the amount of organoclay, in the organoclay/halogenated resin composition, ranges from 0.5 to 20 weight percent. In a preferred embodiment, the amount of organoclay, in the organoclay/halogenated resin composition is about 5 weight percent.

Polymer matrix/organoclay compositions or composites can be prepared via several methods. In an exemplary method, a pelletized polymer matrix and organoclay powder can be mixed together at ambient temperature and then charged into a preheated kneading type mixer such as a Brabender Prep Mixer equipped with roller blades. In another exemplary method, the polymer matrix can be charged to the Brabender Prep Mixer, mixed with heat until a homogenous melt is produced and the organoclay added to the melt with constant mixing. In yet another exemplary method, the composites can also be produced by continuous processing using equipment such as a Buss-Kneader or counter-rotating or conical twin screw extruders. Other exemplary methods may be envisioned by one of skill in the art. Organoclay intercalation or exfoliation can be assessed on the resulting composites using analytical techniques like X-ray diffraction or Transmission Electron Microscopy.

Nanocomposites that are made by these methods using the compositions of this invention may exhibit improved tensile modulus, tensile strength, gas barrier and heat distortion temperature values. Typically, these properties improve when sufficient energy is imparted to the blend to create substantially intercalated or exfoliated organoclay, or mixtures of the organoclay within the polymer matrix.

### EXAMPLES

Compounding is an important step in most plastic fabrication procedures. Additives, such as organoclays, are mixed into a PVC resin during this compounding step to create a mixture that can be processed into a finished product. By using a diverse range of additives, PVC can be made tough and rigid or soft and flexible. However, PVC is easily degraded during the compounding process resulting in color changes and loss of desirable materials properties. Particularly, prolonged exposure to heat and/or shear will exacerbate PVC polymer degradation and result in a darkened plastic. The greater the degradation of the PVC, the darker the plastic becomes.

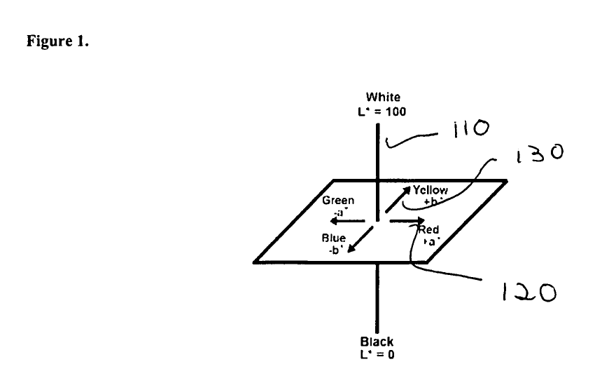

For the following examples, a measurement of color was used as an indicator for the degree of PVC/organoclay composite degradation. FIG. 1 illustrates the CIE L*a*b* color system, in which a material's color is described by its location on three axes. These axes are L* 110 (light-dark), a* 120 (red-green) and b* 130 (blue-yellow). The total color change, ΔE, is determined by the equation ΔE*=[(Δa*)²+(Δb*)²+(ΔL*)²]^{1/2} L*a*b* color measurements were obtained using a Datacolor International spectrophotometer (model# SF600Plus).

In all the following examples the quaternary ammonium compound to clay ratios are based on 100% active clay.

### Comparative Example 1

As a blank, a general purpose flexible grade PVC (Georgia Gulf 8850) that already contained calcium carbonate filler was compounded without further additives in a Brabender mixer for 10 minutes. As expected, the compounding process slightly darkened the plastic. We use this discoloration as a measure of PVC stability.

### Example 1

Bentonite and hectorite based organoclays were prepared with Ethoquad T/13-27W, a tallow triethanol ammonium acetate compound. In a typical synthesis, 110 mMol of quat/100 g of clay, 100% active clay basis, was reacted with clay slurry kept at 65° C. using moderate mixing. After 30 minutes, the reaction was stopped and the organoclay product was isolated by filtering the slurry. The organoclay was dried at 105° C., milled to a fine powder and sieved through a 200 mesh screen. Five weight percent of the organoclay was added to PVC (Georgia Gulf 8850) and compounded in a Brabender mixer for 10 minutes at 170° C. The PVC/bentonite/Ethoquad T/13-27W composite showed a total color change, ΔE, of 15.1 and the PVC/hectorite/Ethoquad T/13-27W composite showed a total color change, ΔE, of 21.6.

Bentonite and hectorite based organoclays were also prepared with Ethoquad HT/12, a methyl diethanol hydrogenated tallow chloride compound. Five weight percent of the organoclay was added to PVC (Georgia Gulf 8850) and compounded in a Brabender mixer for 10 minutes at 170° C. The PVC/bentonite/Ethoquad HT/12 composite showed a total color change, ΔE, of 32 and the PVC/hectorite/Ethoquad HT/12 composite showed a total color change, ΔE, of 39.8.

As shown in Table 1, the PVC composite containing the bentonite/triethanol tallow quat (Ethoquad T/13-27W) organoclay exhibited a smaller ΔE compared to the PVC composite containing the bentonite/Ethoquad HT/12 organoclay. Likewise, the PVC composite containing the hectorite/triethanol tallow quat (Ethoquad T/13-27W) organoclay exhibited a smaller ΔE compared to the PVC composite containing the hectorite/Ethoquad HT/12 organoclay. Therefore, the triethanol quat based organoclays degrade the PVC resin to a much smaller extent when compared to diethanol quat based organoclays.

TABLE 1

| | | Color of the | |
|---|---|---|---|
| | | PVC composite | |
| Experiment # | Organoclay filler used in the PVC | ΔL* | ΔE* |
| 1.1 | Bentonite/2M2HT quat | −68.3 | 68.6 |
| 1.2 | Bentonite/diethanol methyl | −20.5 | 41.5 |
| | hydrogenated tallow quat | | |
| 1.3 | Bentonite/triethanol tallow alkyl | −11.0 | 27.6 |
| | quat | | |
| 1.4 | Bentonite/dihydrogenated tallow | −10.5 | 23.1 |
| | ester quat of methyl triethanol | | |
| | ammonium | | |

### Example 2

Organoclays were produced using white bentonite clay. The CEC for this white bentonite clay was about 105 mMol/100 gram clay (dry basis). In a typical organoclay preparation procedure, clay slurry was charged to a reaction vessel and the slurry was heated to about 65° C. Next, a desired quantity of a quaternary ammonium compound was added to the reactor and the contents were stirred for about 45 minutes. Enough quaternary ammonium compound was added to satisfy 100% of the clay cation exchange capacity. The flocculated organoclay suspension was filtered, dried at 105° C. in a forced air oven and then milled and sieved to −200 mesh.

PVC/organoclay composites were prepared using a Brabender mixer. The PVC used in this example is clear, rigid PVC (Georgia Gulf 9209). PVC was first charged to the mixing bowl and softened at 170° C. prior to organoclay addition. Once the organoclay was added, the composite was compounded at 50 rpm for 12 minutes, after which the composite was removed from the mixing bowl, cooled, and then compression molded into a film or disk. Composites were formulated to contain 3 wt % clay. The color changes are shown in Table 2.

TABLE 2

| | | Color of | |
|---|---|---|---|
| | | the PVC | |
| | | composite | |
| Experiment # | Clay/organoclay filler used in the PVC | ΔL* | ΔE* |
| 2.1 | No filler (PVC only) | −3.0 | 6.8 |
| 2.2 | White Bentonite/PVC | −10.8 | 14.3 |
| 2.3 | White Bentonite exchanged with dimethyl | −64.5 | 64.6 |
| | dihydrogenated tallow quaternary | | |
| | ammonium | | |
| 2.4 | White Bentonite exchanged with | −19.0 | 42.6 |
| | dihydrogenated tallow ester quat of | | |
| | methyl triethanol ammonium | | |
| 2.5 | White Betonite exchanged with | −20.6 | 39.0 |
| | triethanol tallow alkyl | | |
| | quaternary ammonium | | |

The PVC composite made with White Bentonite exchanged with dihydrogenated tallow ester quat of methyl triethanol ammonium showed a change in lightness, ΔL, of −19, and change in total color ΔE of 42.6. The PVC composite made with White Bentonite exchanged with triethanol tallow alkyl quaternary ammonium showed a change in lightness, ΔL, of −20.6, and change in total color ΔE of 39.0. In contrast, White Bentonite exchanged with dimethyl dihydrogenated tallow quaternary ammonium showed significant PVC degradation indicated by a larger change in lightness, ΔL, of −64.5, and a larger change in total color ΔE of 64.6. This composite is almost black.

The values for ΔE and ΔL, show the PVC composites made with the Bentonite/triethanol tallow alkyl quat additive or Bentonite/dihydrogenated tallow ester quat of methyl triethanol ammonium additive have significantly less color degradation compared to the PVC composites containing Bentonite/diethanol methyl hydrogenated tallow quat additive or Bentonite/dimethyl bis[hydrogenated tallow]ammonium (2M2HT) quaternary ammonium compound.

### Example 3

PVC/Organoclay composites were prepared as in Example 3 using a flexible, calcium carbonate filled PVC (Georgia Gulf 8850). The organoclays were prepared with either bentonite or hectorite clay. All organoclays were formulated with 110 mMol quat/100 grams clay (dry basis). The cation exchange capacity (CEC) for the Wyoming bentonite clay used in this example was about 98 mMol/100 gram clay (dry basis) whereas the hectorite clay CEC is about 75 mMol/100 grams (dry basis). The color changes measured for the various PVC/Organoclay composites are shown in Table 3.

TABLE 3

| | Organoclay formulation | | Color of the | | | |
|---|---|---|---|---|---|---|
| Experiment | in PVC | | PVC composite | | | |
| # | Clay | Quat used | ΔL* | Δa* | Δb* | ΔE* |
| 3.1 | Bentonite | Triethanol tallow | −9.5 | 5.5 | 10.4 | 15.1 |
| | | alkyl quat | | | | |
| 3.2 | | Diethanol | −26 | 16.6 | 8.6 | 32 |
| | | methyl | | | | |
| | | hydrogenated | | | | |
| | | tallow alkyl quat | | | | |
| 3.3 | Hectorite | Triethanol tallow | −10.4 | 10.7 | 15.6 | 21.6 |
| | | alkyl quat | | | | |
| 3.4 | | Diethanol | −35.2 | 18.6 | 0.1 | 39.8 |
| | | methyl | | | | |
| | | hydrogenated | | | | |
| | | tallow alkyl quat | | | | |

As shown in Table 3, the PVC/Bentonite Triethanol tallow alkyl quat composite showed a change in lightness, ΔL, of −9.5, and change in total color ΔE of 15.1. In contrast, the PVC/Bentonite Diethanol methyl hydrogenated tallow alkyl quat composite showed significantly higher PVC degradation indicated by a change in lightness, ΔL, of −26, and change in total color ΔE of 32.

The PVC/Hectorite Triethanol tallow alkyl quat composite showed a change in lightness, ΔL, of −10.4, and change in total color, ΔE, of 21.6. In contrast, the PVC/Hectorite Diethanol methyl hydrogenated tallow alkyl quat composite showed significantly higher PVC degradation indicated by a change in lightness, ΔL, of −35.2, and change in total color, ΔE, of 39.8.

### Example 4

PVC/Organoclay composites were prepared as described in Example 4 using the calcium carbonate filled, flexible PVC. The change in color was measured as a function of the amount of triethanol tallow alkyl quaternary ammonium ion exchanged on hectorite clay. The results in Table 4 indicate that when the mMols of the quaternary ammonium cation equals the CEC of the clay, less PVC degradation was observed than when the mMols of the quaternary ammonium cation exceeds the CEC of the clay.

TABLE 4

| | mMols of triethanol | | | | |
|---|---|---|---|---|---|
| Experiment | tallow alkyl quat per | Color of the PVC composite | | | |
| # | CEC of the clay, % | ΔL* | Δa* | Δb* | ΔE* |
| 4.1 | 137 | −10.4 | 10.7 | 15.6 | 21.6 |
| 4.2 | 106 | −5.8 | 4.4 | 10.0 | 12.4 |

The present disclosure may be embodied in other specific forms without departing from the spirit or essential attributes of the invention. Accordingly, reference should be made to the appended claims, rather than the foregoing specification, as indicating the scope of the disclosure. Although the foregoing description is directed to the preferred embodiments of the disclosure, it is noted that other variations and modification will be apparent to those skilled in the art, and may be made without departing from the spirit or scope of the disclosure.

What is claimed:

1. A polymer composition comprising:
a polymer matrix comprising a halogenated polymer;
an organoclay composition comprising:
a phyllosilicate clay;
one or more quaternary ammonium compounds having the formula of: 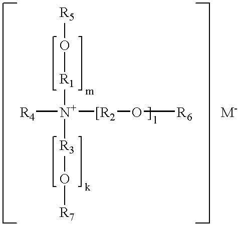
wherein,
R₁, R₂ and R₃ are independently selected from the following: branched or unbranched alkyl chains having from 2 to 22 carbon atoms; and branched or unbranched polyalkylene oxide groups having repeating units from 2 to 6 carbon atoms;
R₄, is selected from the group consisting of:
a linear, branched or cyclic, saturated or unsaturated, cyclic alkyl or acyclic alkyl groups having 1 to 200 carbon atoms, an aralkyl group; and a halogenated alkyl chain; and
R₅, R₆, and R₇ are independently selected from the group consisting of: hydrogen, a linear, cyclic or branched aliphatic, aralkyl, aromatic, halogenated aliphatic group or carboxylic acid residue having 1 to 200 carbon atoms and R₁₀ wherein R₁₀ comprises C(═O)XR₁₁X where X includes a single bond, an oxygen (—O—) or a nitrogen (—NH—), and R₁₁ is selected from the group consisting of a linear, cyclic or branched aliphatic, aralkyl, aromatic, or halogenated aliphatic groups having 1 to 200 carbon atoms,
wherein repeat units k, l, and m are independently selected and have values of 1 to 10.

2. The composition of claim 1, wherein said organoclay comprises a product of the reaction of the phyllosilicate clay and said one or more quaternary ammonium compounds, said one or more quaternary ammonium compounds having an associated anion M⁻ including chloride, bromide, methylsulfate, ethylsulfate, hydroxide, acetate, carbonate, and sulfate.

3. The composition of claim 1, wherein the phyllosilicate clay is selected from the group clays consisting of smectite, mica, vermiculite, synthetic vermiculite, synthetic smectite and synthetic mica.

4. The composition of claim 1, wherein the phyllosilicate clay comprises a smectite clay.

5. The composition of claim 4, wherein said smectite clay includes saponite, stevensite, and beidellite.

6. The composition of claim 4, wherein said smectite clay includes bentonite.

7. The composition of claim 4, wherein said smectite clay includes montmorillonite.

8. The composition of claim 4, wherein said smectite clay includes hectorite.

9. The composition of claim 2, wherein a smectite clay is in the form of a metal cation exchanged clay and M⁻ of the quaternary ammonium compound is selected from the group consisting of chloride, bromide, methylsulfate, ethylsulfate, acetate and sulfate.

10. The composition of claim 2, wherein a smectite clay is in a protonic form and M⁻ of the quaternary ammonium compound is selected from the group consisting of hydroxide, carbonate and acetate.

11. The composition of claim 1, having sufficient quaternary ammonium compound to satisfy 50 to 150 percent of clay cation exchange capacity.

12. The composition of claim 1, having sufficient quaternary ammonium compound to satisfy 75 to 125 percent of clay cation exchange capacity.

13. The composition of claim 1, having sufficient quaternary ammonium compound to satisfy about 100 percent of clay cation exchange capacity.

14. The composition of claim 1, optionally further comprising an intercalated organic material.

15. The composition of claim 14, wherein said organic material comprises neutral organic material.

16. The composition of claim 14, wherein said organic material includes anionic organic material.

17. The composition of claim 1, wherein R₁, R₂ and R₃ include one or more oxygen-containing substituents wherein said substituents are at least beta to nitrogen of said quaternary ammonium compound.

18. The composition of claim 17, wherein R₁, R₂ and R₃ include a hydroxyl group, an ester group and an ether group.

19. The composition of claim 1, wherein at least one of R₅, R₆ and R₇ comprise hydrogen and at least one of R₅, R₆ and R₇ do not comprise hydrogen.

20. The composition of claim 1, wherein R₅, R₆ and R₇ do not comprise hydrogen.

21. The composition of claim 1, wherein R₅, R₆ and R₇ comprise hydrogen.

22. The composition of claim 1, wherein said quaternary ammonium compound is selected from the group of ions consisting of tris[2-hydroxyethyl]tallow alkyl ammonium ion, tris[2-hydroxyethyl]hydrogenated tallow alkyl ammonium ion and tris[2-hydroxyethyl]stearyl alkyl ammonium ion.

23. The composition of claim 1, wherein said quaternary ammonium compound includes tris[2-hydroxyethyl]tallow alkyl ammonium acetate.

24. The composition of claim 1, wherein said quaternary ammonium compound includes dihydrogenated tallow ester quat of methyl triethanol ammonium cation.

25. The composition of claim 1, wherein said polymer matrix is selected from the group of polyvinyl halides consisting of halogenated rubber, polychloroprene, polyvinyl chloride (PVC), polyvinylidene chloride (PVDC), vinylidene chloride-vinyl chloride copolymers, vinyl chloride copolymers, vinylidene fluoride polymers, polyvinylidene fluoride (PVDF) and polytetrafluoroethylene (PTFE).

26. The composition of claim 25, wherein said polymer matrix comprises polyvinyl chloride.

27. The composition of claim 25, wherein said polymer matrix comprises polyvinylidene chloride.

28. The composition of claim 26, said polymer composition having enhanced resistance to discoloration measured by the CIE color system.

29. A polymer composition comprising:
a polymer matrix; and
an organoclay composition comprising:
a phyllosilicate clay;
one or more quaternary ammonium compounds, said quaternary ammonium compounds having an amine degradation product with a pKa less than 8.5.

30. The composition of claim 29, wherein said polymer matrix is selected from the group of polyvinyl halides consisting of halogenated rubber, polychloroprene, polyvinyl chloride (PVC), polyvinylidene chloride (PVDC), vinylidene chloride-vinyl chloride copolymers, vinyl chloride copolymers, vinylidene fluoride polymers, polyvinylidene fluoride (PVDF) and polytetrafluoroethylene (PTFE).

31. The composition of claim 30, wherein said polymer matrix comprises polyvinyl chloride.

32. The composition of claim 30, wherein said polymer matrix comprises polyvinylidene chloride.

33. The composition of claim 31, said polymer composition having enhanced resistance to discoloration measured by the CIE color system.

34. A polymer composition comprising:
a polymer matrix; and
an organoclay composition comprising:
a phyllosilicate clay;
one or more quaternary ammonium compounds having a formula of: 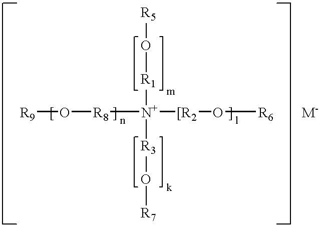
wherein R₁, R₂, R₃ and R₈ are independently selected from the following: branched or unbranched alkyl chains having from 2 to 22 carbon atoms;
wherein R₅, R₆, R₇ and R₉ are independently selected from the group consisting of: hydrogen, wherein a linear, cyclic or branched aliphatic, aralkyl, aromatic, halogenated aliphatic groups or carboxylic acid residue having 1 to 200 carbon atoms, wherein repeat units k, l, and m are independently selected and have values of 1 to 10 and R₁₀; wherein R₁₀ comprises C(═O)XR₁₁ where X includes a single bond, an oxygen (—O—) or a nitrogen (—NH—), and R₁₁ is selected from the group consisting of a linear, cyclic or branched aliphatic, aralkyl, aromatic, or halogenated aliphatic groups having 1 to 200 carbon atoms;
wherein repeat units k, l, m and n are independently selected and have values of 1 to 10.

35. The composition of claim 34, wherein said organoclay comprises a product of the reaction of the phyllosilicate clay and said one or more quaternary ammonium compounds, said one or more quaternary ammonium compounds having an associated anion M⁻ including chloride, bromide, methylsulfate, ethylsulfate, hydroxide, acetate, carbonate, and sulfate.

36. The composition of claim 34, wherein the phyllosilicate clay is selected from the group of clays consisting of smectite, mica, vermiculite, synthetic vermiculite, synthetic smectite and synthetic mica.

37. The composition of claim 34, wherein the phyllosilicate clay comprises a smectite clay.

38. The composition of claim 37, wherein said smectite clay includes saponite, stevensite, and beidellite.

39. The composition of claim 37, wherein said smectite clay includes bentonite.

40. The composition of claim 37, wherein said smectite clay includes montmorillonite.

41. The composition of claim 37, wherein said smectite clay includes hectorite.

42. The composition of claim 35, wherein a smectite clay is in the form of a metal cation exchanged clay and M⁻ is selected from the group consisting of chloride, bromide, methylsulfate, ethylsulfate, acetate and sulfate.

43. The composition of claim 35, wherein a smectite clay is in a protonic form and the counter ion is selected from the group consisting of hydroxide, carbonate and acetate.

44. The composition of claim 34, having sufficient quaternary ammonium compound to satisfy 50 to 150 percent of clay cation exchange capacity.

45. The composition of claim 34, having sufficient quaternary ammonium compound to satisfy 75 to 125 percent of clay cation exchange capacity.

46. The composition of claim 34, having sufficient quaternary ammonium compound to satisfy about 100 percent of clay cation exchange capacity.

47. The composition of claim 34, optionally further comprising an intercalated organic material.

48. The composition of claim 47, wherein said organic material comprises neutral organic material.

49. The composition of claim 47, wherein said organic material includes anionic organic material.

50. The composition of claim 34, wherein R₁, R₂, R₃ and R₈ include one or more oxygen-containing substituents wherein said substituents are at least beta to nitrogen of said quaternary ammonium compound.

51. The composition of claim 50, wherein R₁, R₂, R₃ and R₈ include a hydroxyl group, an ester group and an ether group.

52. The composition of claim 34, wherein at least one of R₅, R₆, R₇ and R₉ comprises hydrogen and at least one of R₅, R₆, R₇ and R₉ do not comprise hydrogen.

53. The composition of claim 34, wherein R₅, R₆, R₇ and R₉ do not comprise hydrogen.

54. The composition of claim 34, wherein R₅, R₆, R₇ and R₉ are comprise hydrogen.

55. The composition of claim 34, wherein said polymer matrix is selected from the group of polyvinyl halides consisting of halogenated rubber, polychloroprene, polyvinyl chloride (PVC), polyvinylidene chloride (PVDC), vinylidene chloride-vinyl chloride copolymers, vinyl chloride copolymers, vinylidene fluoride polymers, polyvinylidene fluoride (PVDF) and polytetrafluoroethylene (PTFE).

56. The composition of claim 55, wherein said polymer matrix comprises polyvinyl chloride.

57. The composition of claim 55, wherein said polymer matrix comprises polyvinylidene chloride.
